(19) United States
(12) Patent Application Publication
(10) Pub. No.: US 2023/0311063 A1
(43) Pub. Date: Oct. 5, 2023

(54) PHOTOCATALYTIC AIRBORNE MOLECULAR CONTAMINATION REMOVAL SYSTEM ENHANCED WITH PASSIVE ADSORPTION

(71) Applicant: ENTEGRIS, INC., Billerica, MA (US)

(72) Inventors: Maryam Irani, Franklin, MA (US); John Gaudreau, Chepachet, RI (US); Reena Srivastava, Franklin, MA (US)

(21) Appl. No.: 18/129,590

(22) Filed: Mar. 31, 2023

Related U.S. Application Data
(60) Provisional application No. 63/325,779, filed on Mar. 31, 2022.

(51) Int. Cl. B01D 53/88; B01D 53/86; B01D 53/02; B01D 53/00; B01J 21/06; B01J 35/00

(52) U.S. Cl. CPC B01D 53/885; B01D 53/8668; B01D 53/02; B01D 53/007; B01J 21/06; B01J 35/004; B01D 2257/708; B01D 2257/55; B01D 2259/80; B01D 2255/802; B01D 2258/06

(57) ABSTRACT

An air filtration system includes a photocatalytic reactor and a first air filter upstream of the photocatalytic reactor. The photocatalytic reactor includes a photocatalyst composition and a lamp configured to irradiate the photocatalyst composition. The photocatalyst composition is configured to decompose one or more volatile organic compounds in the air. The first air filter configured to filter one or more deactivating compounds from the air. A method of filtering air in an air filtration system includes passing air through a photocatalytic reactor and passing the air through a first filter prior to the passing of the air through the photocatalytic reactor. The passing of the air through the photocatalytic reactor includes a photocatalyst composition decomposing one or more volatile organic compounds in the air.

### FIELD

This disclosure relates to air filtration systems. More specifically, this disclosure relates to air filtration systems that produce filtered air for used in semiconductor manufacturing.

### BACKGROUND

Air filtration systems can be employed in semiconductor manufacturing for supplying filtered air to the fabrication areas. An air filtration system can supply clean air to be used by and/or around semiconductor production tools. For example, the clean air may be used as clean purge gas in semiconductor wafer manufacturing. Also, for example, the clean air may be used in a clean room in which semiconductor wafers are manufactured. The air filtration system may be configured to filter the air to remove various contaminants that can negatively impact the quality of semiconductors being produced. For example, such contaminants can include particulates and/or volatile organics that can contaminate the wafer material and reduce the quality of the produced semiconductors.

### SUMMARY

In an embodiment, an air filtration system includes a photocatalytic reactor, a first air filter disposed upstream of the photocatalytic reactor, and a second air filter disposed downstream of the photocatalytic reactor. The photocatalytic reactor includes a photocatalyst composition and a lamp configured to irradiate the photocatalyst composition. The photocatalyst composition is configured to decompose one or more volatile organic compounds in air passing through the photocatalytic reactor. The first air filter is configured to filter one or more compounds from the air. The second air filter is configured to filter at least one of the one or more products from the air passing through the second air filter.

In an embodiment, an air filtration system includes a photocatalytic reactor and an air filter disposed upstream of the photocatalytic reactor. The photocatalytic reactor includes an agitable bed of a photocatalyst composition and a lamp configured to irradiate the photocatalyst composition. The photocatalyst composition configured to decompose one or more volatile organic compounds in air passing through the photocatalytic reactor. The air filter is configured to filter one or more compounds from the air.

A method of filtering air in an air filtration system includes passing air through a photocatalytic reactor that includes a photocatalyst composition and a lamp, and passing the air through a first filter prior to the passing of the air through the photocatalytic reactor. The passing of the air through the photocatalytic reactor includes irradiating, with the lamp, the photocatalyst composition, and decomposing, with the photocatalyst composition, one or more volatile organic compounds in the air into one or more products. The passing of the air through the first filter includes filtering one or more compounds from the air. The method includes passing the air through a second air filter that includes filtering at least one of the one or more products from the air, and/or the passing of the air through the photocatalytic reactor includes passing the air through an agitable bed of the photocatalyst composition.

### DRAWINGS

FIG. 1 is a schematic diagram of an embodiment of an air filtration system 1.

FIG. 2 is a schematic diagram of an embodiment of an air filtration system 1.

FIG. 3 is a block flow diagram of an embodiment of a method of filtering air.

Like numbers represent like features.

### DETAILED DESCRIPTION

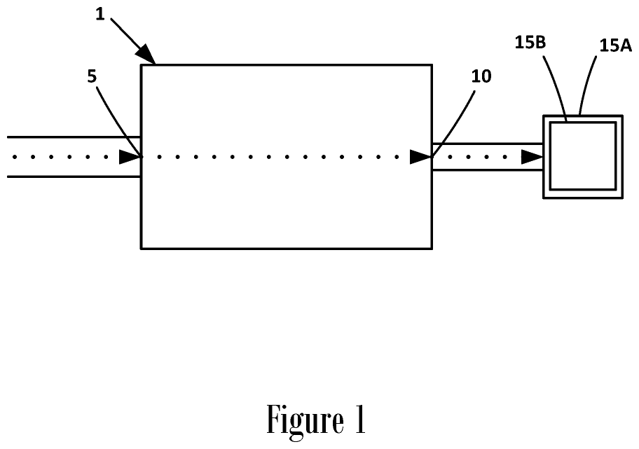

FIG. 1 is a schematic diagram of an embodiment of an air filtration system 1. Airflow of the air filtration is illustrated in dotted arrows in FIG. 1. The air filtration system 1 includes an inlet 5 and an outlet 10. Air to be filtered enters the air filtration system 1 through the inlet 5, flows through the air filtration system 1, and then discharged as filtered air from the air filtration system 1 through the air outlet 10. The air is filtered by the air filtration system 1 as it passes through the air filtration system 1 from the inlet 5 to the outlet 10. The filtered air discharged from air filtration system 1 is then directed to one or more of a clean room 15A and/or semiconductor manufacturing tool(s) 15B. For example, filtered air may be used as clean purge gas in semiconductor manufacturing. For example, the filtered air may be discharged to a clean room 15A used in semiconductor manufacturing. In another embodiment, the air filtration system 1 may be used for providing highly clean air in other clean environments than semiconductor manufacturing (e.g., in hospitals, in other types of manufacturing, etc.).

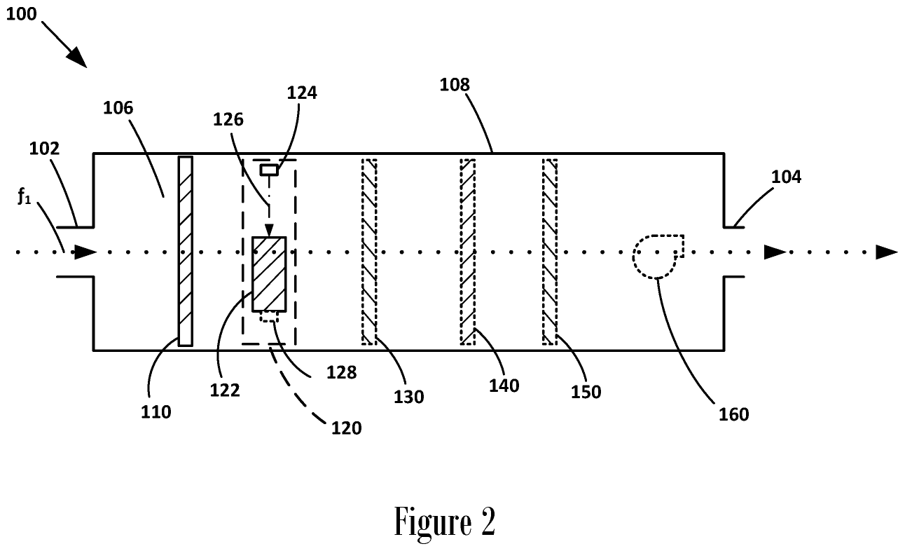

FIG. 2 is a schematic diagram of an embodiment of an air filtration system 100. In an embodiment, the air filtration system 100 may be the air filtration in FIG. 1. Dotted arrows are provided to indicate the flow of air through the air filtration system 100 in FIG. 1.

As shown in FIG. 2, the air filtration system 100 includes an inlet 102 and an outlet 104, and an air flow path 106 that extends from the inlet 102 to the outlet 104. Air enters the air filtration system 100 through the inlet 102, flows from inlet 102 to the outlet 104 through the air flow path 106, and then the air (e.g., filtered air) is discharged from the outlet 104. The air is filtered as it flows through the air flow path 106 of the air filtration system 100.

The air filtration system 100 includes a photocatalytic reactor 120 and one or more filters 110, 130, 140, 150. Air is filtered by the air filtration system 100 by passing through the photocatalytic reactor 120 and the filter(s) 110, 130, 140, 150. In the illustrated embodiment, the air filtration system 100 includes a first filter 110, the photocatalytic reactor 120, a second filter 130, a third filter 140, and a fourth filter 150. The air flows through the first filter 110, a photocatalytic reactor 120, the second filter 130, the third filter 140, and then the fourth filter 150 in that order. In an embodiment, the air filtration system 100 may also include an air displacement device 160, such as a blower or fan, for generating the flow of through the air filtration system 100 (e.g., air to flow through the air flow path 106 of the air filtration path 100).

The inlet air f₁ (e.g., air to be filtered) flowing into the inlet 102 of the air filtration system 100 can be one or mixture of ambient air (e.g., air from outside the building), internal building air, clean room return air, etc. The first filter 100 is disposed upstream of the photocatalytic reactor 120. It should be appreciated that “upstream” and “downstream” as described are with respect to the direction of the flow of the air through the air filtration system 100 from its inlet 102 to its outlet 104 (e.g., position in the air flow path 106 with respect to the flow of air from the inlet 102 to the outlet 104). For example, disposed upstream of the photocatalytic reactor 120 refers to first filter 100 being closer to the inlet 102 such that the air passes through the first filter 100 before flowing into the photocatalytic reactor 120 (e.g., air flowing through the photocatalytic reactor 120 has passed through the first filter 110).

The inlet air f₁ includes one or more contaminants. The contaminants include one or more volatile organic compounds. For example, volatile organic compounds can include, but are not limited to, isopropyl alcohol (IPA), toluene, acetic acid, acetone, propylene glycol methyl ether acetate, trimethylsilanol, acetaldehyde, benzene, ethanol, ethylbenzene, and the like. The photocatalytic reactor 120 is used for removing/reducing the amount of volatile organic compound(s) from the air. In an embodiment, the photocatalytic reactor 120 can be used for reducing the content of IPA in the air.

The photocatalytic reactor 120 includes a photocatalyst composition 122 and a lamp 124. The lamp 124 produces light 126 that is directed onto the photocatalyst composition 122. The lamp 124 can be in the form of an LED or other adequate light source. The photocatalyst composition 122 and the lamp 124 may be disposed with or without separate housing/unit within the air filtration system 100.

The light 126 activates the photocatalyst composition 122 which then oxidizes the volatile organic compound(s) in the air. More specifically, the photocatalyst composition 122 decomposes the volatile organic compound(s) into one or more products. Photocatalytic reactions are initiated when the photocatalyst(s) in the photocatalyst composition 122 absorb photons from the light 126 with energies equal to or greater than the bandgap energy of the photocatalyst(s), which results in the formation of an electron-hole pair (e⁻/h⁺) on the surface of the photocatalyst(s). The formed electron-hole pair reacts with oxygen (O₂) and water/moisture (H₂O) in the air forming active radicals (O₂·⁻ and OH·) which then react with the volatile organic compound(s) resulting in the decomposition of the volatile organic compound(s). Volatile organic pollutants/compounds generally decomposed into carbon dioxide (CO₂) and water (H₂O) as main products. It should be appreciated that references to compound(s) and/or specie(s) reacting with or being decomposed by the photocatalyst composition 122 refers to reaction with the active radicals generated by the photocatalyst composition 122, unless specified otherwise. The one or more product(s) are then discharged from the photocatalytic reactor 120 along with the air. Some organic species may also form other specie(s)/compound(s) (i.e., other than carbon dioxide and the water) during decomposition (e.g., may only be partially decomposed, form intermediates that do not further decompose, etc.). These other specie(s)/compound(s) may be referred to as by-products.

The photocatalyst composition 122 is one or more photocatalyst(s) that when irradiated are capable of decomposing volatile organic compound(s) that can contaminate air. The irradiated photocatalyst(s) generate free-radicals in the air that react with and decompose the volatile organic compounds, as discussed above. In an embodiment, the photocatalyst composition 122 may be in the form of a metal oxide semiconductor and/or a doped metal oxide semiconductor. Examples of the photocatalytic include one or more of, but is not limited to, TiO₂, ZnO, Fe—TiO₂, Ce—TiO₂, and the like.

The photocatalyst composition 122 can be provided on a carrier. In an embodiment, the photocatalyst composition 122 may be a coating provided a solid substrate (e.g., a TiO₂ coating provided on an aluminum substrate). In an embodiment, the photocatalyst composition 122 may be provided on a porous material (e.g., a filter material, on porous fiber structure, or the like) such that air flows across the photocatalyst composition 122 as the air passes through the porous material. In an embodiment, the photocatalyst composition 122 may be provided in the form of a packed bed.

In an embodiment, the photocatalyst composition 122 may be provided in the form of an agitable bed in the photocatalytic reactor 120. For example, the photocatalyst composition 122 may be provided as a coating on substrate beads/particles of the agitable bed. In such an embodiment, the photocatalytic reactor 120 includes the agitable bed of the photocatalyst composition 122. In an embodiment, the agitable bed may be fluidized bed that is agitated by the air flowing through the photocatalytic reactor 120. In an embodiment, the agitable bed may be a fixed bed and the photocatalytic reactor 120 includes a mechanical means of agitating the fixed bed of the photocatalyst composition. For example, mechanical means 128 may be one or more of a stirrer that stirs the beads within the fixed bed, a rotator that rotates the entire fixed bed to agitate the beads in the fixed bed, a rotator that rotates one or more portions of the fixed bed (e.g., rotating the side(s) of the fixed bed, etc.) causing agitation of the beads in the fixed bed, or the like.

The inlet air f₁ can include one or more other compound(s) different from the volatile organic compound(s). These other compounds are gaseous contaminants in the air. These other compound(s) can deactivate the photocatalyst and/or react with the photocatalyst to produce other unwanted contaminants. Such produced compounds are different from the main products (i.e., are not H₂O and/or CO₂) and can be referred to as by-products. For example, some of the other compound(s) can be those that are oxidized by the photocatalyst(s) to form one or more oxidation products that are not H₂O and/or CO₂. A first type of by-product remains and blocks an active site of the photocatalyst, which decreases the activity of the photocatalyst. This can be referred to as deactivating the photocatalyst. A second type of by-product is discharged from the photocatalyst composition 122 along with the air becoming a contaminant/pollutant in the air. Some by-products may both deactivate the photocatalyst composition 122 and be discharged from the photocatalyst composition 122 along with the air (e.g., discharged from the photocatalyst composition 122/photocatalytic reactor 120 as a pollutant in the air).

These other compounds in the inlet air f₁ can include one or more inorganic compounds that deactivate the photocatalyst composition 122 and/or silicon compounds that deactivate the photocatalyst composition 122. One or more pollutant by-products may be created via the photooxidation process. For example, inorganic compounds (e.g., SO₂, H₂S, NH₃, or the like) can be oxidized by the photocatalyst(s) to produce by-product(s) (e.g., SO4²⁻, H₂SO₄, NO₂, HNOx, or the like) which may be discharged from the photocatalyst composition 122 as a pollutant by-product(s) in the air and/or may remain and block active sites of the photocatyst(s) (i.e., photocatalyst composition 122). For example, silicon compounds that deactivate the photocatalyst composition 122 are silicon compounds (e.g., hexamethyldisiloxane (HMDSO), or the like) that react with the photocatalyst(s) to produce by-products (e.g., SiO₂, SiO₃²⁻) which then block active sites of the photocatalyst(s).

The first filter 110 is disposed upstream of the photocatalytic reactor 120. Air f₁ flows from the inlet 102 to the first filter 110 and is filtered by the first filter 110 prior to passing through the photocatalytic reactor 120. The first filter 110 is an air filter configured to filter at least one of the one or more compounds from the air f₁. The first filter 100 includes material that adsorbs one or more compounds from the air f₁. For example, the first filter 110 in an embodiment may include one or more of carbon (e.g., treated carbon, untreated carbon), zeolite, an ion exchange resin, and the like that are configured to adsorb the one or more compound(s) from the air f₁.

The second filter 130 is disposed downstream of the photocatalytic reactor 120. The second filter 130 receives the air discharged from the photocatalytic reactor 120. The second filter 130 is a particulate air filter configured to remove particulates from the air discharged from the photocatalytic reactor 120. Examples of particulate filters can include, but are not limited to, a HEPA air filter and a ULPA air filters. In an embodiment, the second filter 130 is configured to filter particulates discharged from the photocatalytic reactor 120. The second filter 130 can filter particulates of the photocatalyst composition 122 discharged from the fluidized bed of the photocatalytic reactor 120. The second filter 130 is configured to filter the particulates of the fluidized bed of photocatalyst composition 122 in the air flowing from the photocatalytic reactor 120.

The third air filter 140 is disposed downstream of the photocatalytic reactor 120. In the illustrated embodiment, the third air filter 140 is disposed downstream of the photocatalytic reactor 120 and the second filter 130. The third air filter 140 is an air filter configured to filter the air after passing through the photocatalytic reactor 120. The third filter 140 is configured to filter the one or more products produced by the photocatalytic reactor 120 from the air f₁. In an embodiment, the third filter 140 may be configured to filter one or more by-product produced in the photocatalyst composition 122 from the air f₁. The third filter 140 adsorbs the product(s) from the air f₁. For example, the first filter 110 in an embodiment may include one or more of carbon (e.g., treated carbon, untreated carbon), zeolite, an ion exchange resin, and the like that are configured to adsorb one or more deactivating compound(s) from the air f₁. In an embodiment, the third filter 140 may be the same type of air filter as the first filter 110 (e.g., the first filter 110 and the third filter 140 being made of the same type of material(s)). In another embodiment, the third filter 140 and the first filter 110 may be different types of filters (e.g., made of different materials).

The fourth filter 150 is disposed downstream of the third filter 140. The fourth filter 150 is an air filter configured to filter the air f₁ after passing through the third filter 140. The fourth filter 150 is a particulate filter configured to filter particulates from the air f₁. In particular, the fourth filter 150 is configured to filter any particulates discharged into the air from the third filter 140. Examples of particulate filters can include, but are not limited to, a HEPA air filter and a ULPA air filter. The fourth filter 150 may be the same or a different type of particulate filter from the second filter 130.

It should be appreciated that the filters 110, 130, 140, 150 are referred to as first, second, third, and fourth to provide a clearer description and should not be interpreted as limiting the position/configuration of any particular filter. For example, the total number and/or a particular arrangement of filters within the air filtration system 100 may be different in other embodiments. In one embodiment, the air filtration system 100 may include the first filter 110 and the photocatalytic reactor 120. In another embodiment, the air filtration system 100 may include the first filter 110, the photocatalytic reactor 120, and one or more of the second filter 130, the third filter 140, and the fourth filter 150. In one embodiment, the air filtration system 100 may include the first filter 110, the photocatalytic reactor 120, and the third filter 140.

In an embodiment, the air filtration system 100 may be in the form of a single housing 108. For example, the housing 108 may be in the form of an air filtering cabinet or unit. The housing 108 including the inlet 102 and the outlet 104. The photocatalytic reactor 120 and the one or more filter(s) 110, 130, 140, 150 disposed within the housing 108. In an embodiment, the air filtration system 100 may include multiple photocatalytic reactors 120 in parallel. For example, the air from the first filter 110 is split into multiple streams which each pass through a respective one of the multiple photocatalytic reactors 120. The air discharged from each of the multiple photocatalytic reactors 120 can then be directed to the next air filter (e.g., the second air filter 130).

The air filtration system 100 can be configured to filter at least 100 cubic feet per minute (“CFM”) of air. The air filtration system 100 can be configured to filter at least 100 cubic feet per minute (“CFM”) of air. In an embodiment, the air filtration system 100 can be configured to filter at least 200 CFM of air. In an embodiment, the air filtration system 100 can be configured to filter at least 200-500 CFM of air.

For example, conventional air filtrations systems for providing filtered air to semiconductor manufacturing tools have utilized a carbon filter to remove volatile organic compound(s) from the air were replaced regularly (e.g., more than monthly, at or about monthly, at or about bi-monthly, at or about semi-annually, etc.) (e.g., carbon filter used for removing IPA are replaced at or less monthly). One example is carbon filters used for removing IPA are generally replaced at least monthly. For example, the removal efficiency of such carbon filters dropped below 60% removal efficiency after filtering 6,000 ppb-hrs of IPA from the air. The air filtration system 100 can advantageously providing filtering of volatile organic compound(s) for a sustained period without maintenance (e.g., without replacing its one or more filter(s), without replacing the filters 110, 130, 140, 150 in the illustrated embodiment).

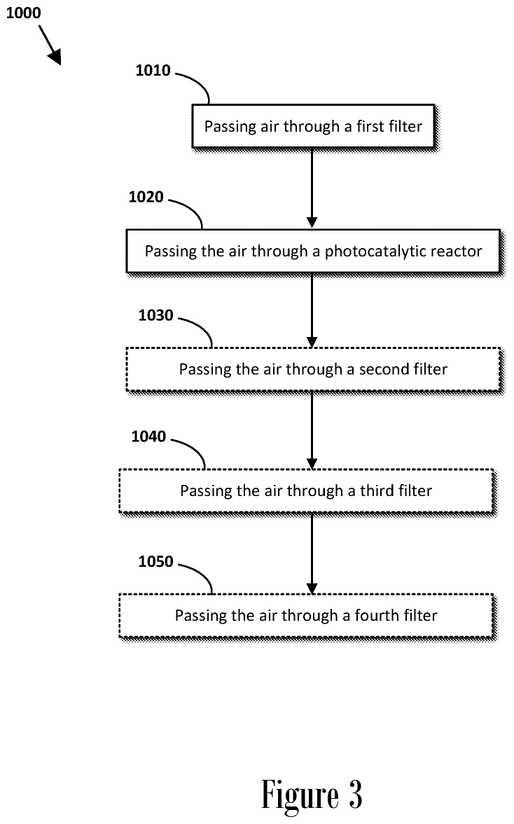

FIG. 3 is a block flow diagram of a method of filtering air 1000. For example, the method 100 may be employed by the air filtration system 1 of FIG. 1 and/or the air filtration system 100 of FIG. 2. The method 1000 starts at 1010.

At 1010, the air is passed through a first filter (e.g., first air filter 110). The passing of the air through the first filter at 1010 includes filtering one or more deactivating compounds from the air. The method 1000 then proceeds to 1020.

At 1020, the air is passed through a photocatalytic reactor (e.g., photocatalytic reactor 120). The air is passed through the first filter at 1010 prior to being passed through the photocatalytic reactor at 1020 within the air filtration system. The passing of the air through the photocatalytic reactor at 1020 includes irradiating, with a lamp (e.g., lamp 124), a photocatalyst composition (e.g., photocatalyst composition 122), and decomposing, with the photocatalyst composition, one or more volatile organic compounds in the air into one or more products. In an embodiment, the photocatalytic reactor includes a fluidized bed of the photocatalyst composition, and passing the air through the photocatalytic reactor at 1020 includes passing the air through the fluidized bed of the photocatalyst composition. In an embodiment, the method 1000 may then proceed to 1030.

At 1030, the air is passed through a second filter (e.g., second air filter 130). Passing the air through the second filter at 1030 can include filtering particulates from the air. In an embodiment, filtering particulates from the air can include filtering, with the second filter, particulates of the photocatalytic compassion of the fluidized bed from the air. In an embodiment, the method 1000 may then proceed to 1040.

At 1040, the air is passed through a third filter (e.g., third air filter 140). Passing the air through the third filter at 1040 can include filtering, with the third filter, at least one of the one or more products produced at 1020 from the air. In an embodiment, the method 1000 may then proceed to 1050.

At 1050, the air is passed through a fourth filter (e.g., fourth air filter 150). Passing the air through the filter at 1040 can include filtering particulates from the air (e.g., particulates of the third filter 140 discharged into the air).

It should be appreciated that the method 1000 in an embodiment may be modified to include features as described for the air filtration system 1 in FIG. 1 and/or the air filtration system 100 in FIG. 2.

Aspects:

Any of Aspects 1-8 may be combined with any of Aspects 9-20, and any of Aspects 9-16 may be combined with any of Aspects 17-20.

Aspect 1. An air filtration system, comprising: a photocatalytic reactor including a photocatalyst composition and a lamp configured to irradiate the photocatalyst composition, the photocatalyst composition configured to decompose one or more volatile organic compounds in air passing through the photocatalytic reactor into one or more products; and a first air filter disposed upstream of the photocatalytic reactor to filter the air prior to the photocatalytic reactor, the first air filter configured to filter one or more compounds from the air; and a second air filter disposed downstream of the photocatalytic reactor, the second air filter configured to filter at least one of the one or more products from the air passing through the second air filter.

Aspect 2. The air filtration system of Aspect 1, further comprising: an inlet and an outlet, the air flowing from the inlet to the outlet through the first air filter, the photocatalytic reactor, and the second air filter in that order.

Aspect 3. The air filtration system of any one of Aspects 1-2, wherein the one or more compounds filtered by the first air filter include one or more of: an inorganic compound that deactivates the photocatalyst composition and a silicon compound that deactivates the photocatalyst.

Aspect 4. The air filtration system of any one of Aspects 1-3, further comprising: a third air filter disposed to filter the air flowing from the photocatalytic reactor, the third air filter being a particulate filter configured to filter solid particulates from the air.

Aspect 5. The air filtration system of Aspect 4, further comprising: a fourth air filter disposed to filter the air flowing from the second air filter, the fourth air filter being a particulate filter configured to filter solid particulates discharged from the second air filter, wherein the third air filter is disposed to filter air flowing from the photocatalytic reactor to the second air filter, the third air filter configured to filter solid particulates of the photocatalyst composition discharged from the photocatalytic reactor.

Aspect 6. The air filtration system of any one of Aspects 1-5, further comprising: a housing containing the first air filter, the photocatalytic reactor, and the second air filter, the housing forming a flow path that directs the air through the first air filter, the fluidized bed of the photocatalytic reactor, and the second air filter in that order.

Aspect 7. The air filtration system of any one of Aspects 1-6, wherein the one or more volatile compounds include isopropyl alcohol, the photocatalyst composition configured to decompose the isopropyl alcohol.

Aspect 8. The air filtration system of any one of Aspects 1-7, wherein the photocatalytic reactor includes an agitable bed of the photocatalyst composition.

Aspect 9. An air filtration system, comprising: a photocatalytic reactor including an agitable bed of a photocatalyst composition and a lamp configured to irradiate the photocatalyst composition, the photocatalytic reactor configured to agitate the agitable bed of the photocatalyst composition, the photocatalyst composition configured to decompose one or more volatile organic compounds in air passing through the photocatalytic reactor into one or more products; and a first air filter disposed upstream of the photocatalytic reactor to filter the air prior to passing through the photocatalytic reactor, the first air filter configured to filter one or more compounds from the air.

Aspect 10. The air filtration system of aspect 9, wherein the agitable bed is a fluidized bed, or the agitable bed is a fixed bed, and the photocatalytic reactor includes a means of mechanically agitating the fixed bed of the photocatalyst composition.

Aspect 11. The air filtration system of any one of Aspects 9-10, further comprising: a second air filter disposed downstream of the photocatalytic reactor, the second air filter being a particulate air filter configured to filter particles of the photocatalyst composition discharged from agitable bed from the air.

Aspect 12. The air filtration system of Aspect 11, further comprising: a third air filter disposed to filter the air flowing from the second air filter, the third air filter configured to filter at least one of the one or more products from the air passing through the third air filter.

Aspect 13. The air filtration system of any one of Aspects 9-12, further comprising: an inlet and an outlet, the air flowing from the inlet to the outlet through the first air filter and the photocatalytic reactor in that order.

Aspect 14. The air filtration system of any one of Aspects 9-12, wherein the one or more compounds filtered by the first air filter include one or more of: an inorganic compound that deactivates the photocatalyst composition and a silicon compound that deactivates the photocatalyst.

Aspect 15. The air filtration system of any one of Aspects 9-14, further comprising: a housing containing the photocatalytic reactor and the first air filter, the housing forming a flow path that directs the air through the first air filter and the agitable bed of the photocatalytic reactor in that order.

Aspect 16. The air filtration system of any one of Aspects 9-15, wherein the one or more volatile compounds include isopropyl alcohol, the photocatalyst composition configured to decompose the isopropyl alcohol.

Aspect 17. A method of filtering air in an air filtration system, comprising: passing air through a photocatalytic reactor that includes a photocatalyst composition and a lamp, which includes irradiating, with the lamp, the photocatalyst composition, and decomposing, with the photocatalyst composition, one or more volatile organic compounds in the air into one or more products; and passing the air through a first filter prior to the passing of the air through the photocatalytic reactor, wherein the passing of the air through the first filter includes filtering one or more deactivating compounds from the air that deactivate the photocatalyst, wherein one or more of: the method includes passing the air through a second air filter that includes filtering at least one of the one or more products from the air, and the passing of the air through the photocatalytic reactor includes passing the air through an agitable bed of the photocatalyst composition.

Aspect 18. The method of Aspect 17, comprising: the passing of the air through the second air filter.

Aspect 19. The method of Aspect 18, wherein the passing of the air through the photocatalytic reactor includes the passing of the air through the agitable bed of the photocatalyst composition.

Aspect 20. The method of Aspect 19, further comprising: passing the air through a particulate filter to filter solid particulates of the photocatalyst composition discharged from the agitable bed, the agitable bed being a fluidized bed of the photocatalyst composition.

The examples disclosed in this application are to be considered in all respects as illustrative and not limitative. The scope of the disclosure is indicated by the appended claims rather than by the foregoing description; and all changes which come within the meaning and range of equivalency of the claims are intended to be embraced therein.

1. An air filtration system, comprising:
a photocatalytic reactor including a photocatalyst composition and a lamp configured to irradiate the photocatalyst composition, the photocatalyst composition configured to decompose one or more volatile organic compounds in air passing through the photocatalytic reactor into one or more products;
a first air filter disposed upstream of the photocatalytic reactor to filter the air prior to the photocatalytic reactor, the first air filter configured to filter one or more compounds from the air; and
a second air filter disposed downstream of the photocatalytic reactor, the second air filter configured to filter at least one of the one or more products from the air passing through the second air filter.

2. The air filtration system of claim 1, further comprising:
an inlet and an outlet, the air flowing from the inlet to the outlet through the first air filter, the photocatalytic reactor, and the second air filter in that order.

3. The air filtration system of claim 1, wherein the one or more compounds filtered by the first air filter include one or more of:
an inorganic compound that deactivates the photocatalyst composition and a silicon compound that deactivates the photocatalyst.

4. The air filtration system of claim 1, further comprising:
a third air filter disposed to filter the air flowing from the photocatalytic reactor, the third air filter being a particulate filter configured to filter solid particulates from the air.

5. The air filtration system of claim 4, further comprising:
a fourth air filter disposed to filter the air flowing from the second air filter, the fourth air filter being a particulate filter configured to filter solid particulates discharged from the second air filter, wherein
the third air filter is disposed to filter air flowing from the photocatalytic reactor to the second air filter, the third air filter configured to filter solid particulates of the photocatalyst composition discharged from the photocatalytic reactor.

6. The air filtration system of claim 1, further comprising:
a housing containing the first air filter, the photocatalytic reactor, and the second air filter, the housing forming a flow path that directs the air through the first air filter, a fluidized bed of the photocatalytic reactor, and the second air filter in that order.

7. The air filtration system of claim 1, wherein the one or more volatile organic compounds include isopropyl alcohol, the photocatalyst composition configured to decompose the isopropyl alcohol.

8. The air filtration system of claim 1, wherein the photocatalytic reactor includes an agitable bed of the photocatalyst composition.

9. An air filtration system, comprising:
a photocatalytic reactor including an agitable bed of a photocatalyst composition and a lamp configured to irradiate the photocatalyst composition, the photocatalytic reactor configured to agitate the agitable bed of the photocatalyst composition, the photocatalyst composition configured to decompose one or more volatile organic compounds in air passing through the photocatalytic reactor into one or more products; and
a first air filter disposed upstream of the photocatalytic reactor to filter the air prior to passing through the photocatalytic reactor, the first air filter configured to filter one or more compounds from the air.

10. The air filtration system of claim 9, wherein the agitable bed is a fluidized bed, or the agitable bed is a fixed bed, and the photocatalytic reactor includes a means of mechanically agitating the fixed bed of the photocatalyst composition.

11. The air filtration system of claim 9, further comprising:
a second air filter disposed downstream of the photocatalytic reactor, the second air filter being a particulate air filter configured to filter particles of the photocatalyst composition discharged from agitable bed from the air.

12. The air filtration system of claim 11, further comprising:
a third air filter disposed to filter the air flowing from the second air filter, the third air filter configured to filter at least one of the one or more products from the air passing through the third air filter.

13. The air filtration system of claim 12, further comprising:
an inlet and an outlet, the air flowing from the inlet to the outlet through the first air filter and the photocatalytic reactor in that order.

14. The air filtration system of claim 9, wherein the one or more compounds filtered by the first air filter include one or more of:
an inorganic compound that deactivates the photocatalyst composition, and a silicon compound that deactivates the photocatalyst.

15. The air filtration system of claim 9, further comprising:
a housing containing the photocatalytic reactor and the first air filter, the housing forming a flow path that directs the air through the first air filter and the agitable bed of the photocatalytic reactor in that order.

16. The air filtration system of claim 9, wherein the one or more volatile compounds include isopropyl alcohol, the photocatalyst composition configured to decompose the isopropyl alcohol.

17. A method of filtering air in an air filtration system, comprising:
passing air through a photocatalytic reactor that includes a photocatalyst composition and a lamp, which includes:
irradiating, with the lamp, the photocatalyst composition, and
decomposing, with the photocatalyst composition, one or more volatile organic compounds in the air into one or more products; and
passing the air through a first filter prior to the passing of the air through the photocatalytic reactor, wherein the passing of the air through the first filter includes filtering one or more deactivating compounds from the air that deactivate the photocatalyst,
wherein one or more of:
the method includes passing the air through a second air filter that includes filtering at least one of the one or more products from the air, and
the passing of the air through the photocatalytic reactor includes passing the air through an agitable bed of the photocatalyst composition.

18. The method of claim 17, comprising:
the passing of the air through the second air filter.

19. The method of claim 17, wherein the passing of the air through the photocatalytic reactor includes the passing of the air through the agitable bed of the photocatalyst composition.

20. The method of claim 19, further comprising:
passing the air through a particulate filter to filter solid particulates of the photocatalyst composition discharged from the agitable bed, the agitable bed being a fluidized bed of the photocatalyst composition.
